(19) United States
(12) Patent Application Publication
(10) Pub. No.: US 2025/0334354 A1
(43) Pub. Date: Oct. 30, 2025

(54) CONTOURED INLET MANIFOLD FOR SUBFREEZING HEAT EXCHANGER

(71) Applicant: Hamilton Sundstrand Corporation, Charlotte, NC (US)

(72) Inventors: Kathryn L. Kirsch, East Haddam, CT (US); Louis J. Bruno, Ellington, CT (US); Darryl Colson, West Suffield, CT (US); Eugene F. Ucol, Cromwell, CT (US); Hailing Wu, Glastonbury, CT (US); Ram Ranjan, San Diego, CA (US)

(21) Appl. No.: 18/644,545

(22) Filed: Apr. 24, 2024

(51) Int. Cl. F28F 9/02; B64D 13/06

(52) U.S. Cl. CPC F28F 9/0214; B64D 2013/0603; F28F 2009/029

(57) ABSTRACT

A component for use in an environmental control system includes an inlet portion having a longitudinal axis, an inlet formed at the inlet portion, and an outlet portion including a front side and a back side. The front side is arranged closer to the inlet portion than the back side. An outlet is formed at the outlet portion and is arranged at a non-parallel angle relative to the inlet. An intermediate portion extends between and fluidly couples the inlet portion and the outlet portion. The intermediate portion includes a reservoir spaced laterally from the back side of the outlet portion and offset from the longitudinal axis of the inlet portion.

### BACKGROUND

Embodiments of the present disclosure relate to environmental control systems for a vehicle, and more particularly, to a heat exchanger within the environmental control system.

Environmental control systems that provide cooling to various heat loads may operate utilizing expanding fluids flowing from an outlet of a turbine. Such airflows generally have high velocities and may be at sub-freezing temperatures. Such airflows may not be evenly distributed upon entering a heat exchanger such as due to the small area of the turbine exhaust compared to the flow area of the heat exchanger inlet face or to a bend or turn in the flow path between the turbine and the heat exchanger. Such airflows may contain ice or snow created through the expansion cooling of air through the turbine, which can accumulate on, and may block portions of inlet face of a downstream heat exchanger. The airflow may also be non-uniformly distributed, thus being preferentially directed to only a portion of the inlet face of the heat exchanger. Non-uniform distribution of a high velocity, sub-freezing fluid flow may prevent the heat exchanger from operating in a most efficient manner.

### BRIEF DESCRIPTION

According to an embodiment, a component for use in an environmental control system includes an inlet portion having a longitudinal axis, an inlet formed at the inlet portion, and an outlet portion including a front side and a back side. The front side is arranged closer to the inlet portion than the back side. An outlet is formed at the outlet portion and is arranged at a non-parallel angle relative to the inlet. An intermediate portion extends between and fluidly couples the inlet portion and the outlet portion. The intermediate portion includes a reservoir. The reservoir is spaced laterally from the back side of the outlet portion and offset from the longitudinal axis of the inlet portion.

In addition to one or more of the features described above, or as an alternative, in further embodiments the intermediate portion at the back side is spaced from the longitudinal axis.

In addition to one or more of the features described above, or as an alternative, in further embodiments the inlet portion is offset from the outlet portion in a plurality of axes.

In addition to one or more of the features described above, or as an alternative, in further embodiments a flow path extends between the inlet and the outlet and the reservoir is offset from the inlet portion such that the flow path includes a turn from a downstream end of the inlet portion toward the reservoir.

In addition to one or more of the features described above, or as an alternative, in further embodiments a flow path extends between the inlet and the outlet and the reservoir is offset from the outlet portion such that the flow path includes a turn from the reservoir toward the outlet portion.

In addition to one or more of the features described above, or as an alternative, in further embodiments the reservoir extends over only a portion of an axial length of the outlet portion between the front side and the back side.

In addition to one or more of the features described above, or as an alternative, in further embodiments the intermediate portion includes a plurality of sidewalls and the plurality of sidewalls define the reservoir.

In addition to one or more of the features described above, or as an alternative, in further embodiments an interface between adjacent sidewalls of the plurality of sidewalls are curved.

In addition to one or more of the features described above, or as an alternative, in further embodiments at least one of the plurality of sidewalls is contoured such that a cross-sectional area of the component gradually increases between the reservoir and the outlet portion.

In addition to one or more of the features described above, or as an alternative, in further embodiments the plurality of sidewalls includes a back sidewall extending between the reservoir and the back side of the outlet portion, the back sidewall having a concave curvature.

In addition to one or more of the features described above, or as an alternative, in further embodiments the outlet is perpendicular to the inlet.

According to an embodiment, a component for use in an environmental control system includes an inlet portion having a longitudinal axis, an inlet formed at the inlet portion, and an outlet portion including a front side and a back side. The front side is arranged closer to the inlet portion than the back side. An outlet formed at the outlet portion is arranged at a non-parallel angle relative to the inlet. An intermediate portion extends between and fluidly couples the inlet portion and the outlet portion. The intermediate portion is contoured such that the intermediate portion is offset from the longitudinal axis at the back side of the outlet portion.

In addition to one or more of the features described above, or as an alternative, in further embodiments the inlet portion is offset from the outlet portion in a plurality of axes.

In addition to one or more of the features described above, or as an alternative, in further embodiments the intermediate portion includes a plurality of sidewalls and an interface between adjacent sidewalls of the plurality of sidewalls are curved.

In addition to one or more of the features described above, or as an alternative, in further embodiments at least one of the plurality of sidewalls is contoured such that a cross-sectional area of the component gradually increases upstream from the outlet portion.

In addition to one or more of the features described above, or as an alternative, in further embodiments at least one of the plurality of sidewalls has a concave curvature.

In addition to one or more of the features described above, or as an alternative, in further embodiments the intermediate portion includes a reservoir, the reservoir being offset from the longitudinal axis of the inlet portion.

In addition to one or more of the features described above, or as an alternative, in further embodiments the reservoir is spaced laterally from the back side of the outlet portion.

In addition to one or more of the features described above, or as an alternative, in further embodiments the intermediate portion includes a plurality of sidewalls and the plurality of sidewalls define the reservoir.

### BRIEF DESCRIPTION OF THE DRAWINGS

The following descriptions should not be considered limiting in any way. With reference to the accompanying drawings, like elements are numbered alike:

FIG. 1 is a schematic diagram of a portion of an environmental control system of an aircraft; and

FIG. 2 is a schematic diagram of previous header defining a turn within a flow path of the environmental control system;

FIG. 3 is a plan view of a header defining a turn within a flow path of the environmental control system according to an embodiment;

FIG. 4 is a front perspective view of the header of FIG. 3 according to an embodiment;

FIG. 5 is a rear perspective view of the header of FIG. 3 according to an embodiment;

FIG. 6 is an upstream end view of the header of FIG. 3 according to an embodiment;

FIG. 7 is a rear view of the header of FIG. 3 according to an embodiment; and

FIG. 8 is a cross-sectional view of the header taken at various locations along the flow path of the header according to an embodiment.

### DETAILED DESCRIPTION

A detailed description of one or more embodiments of the disclosed apparatus and method are presented herein by way of exemplification and not limitation with reference to the Figures.

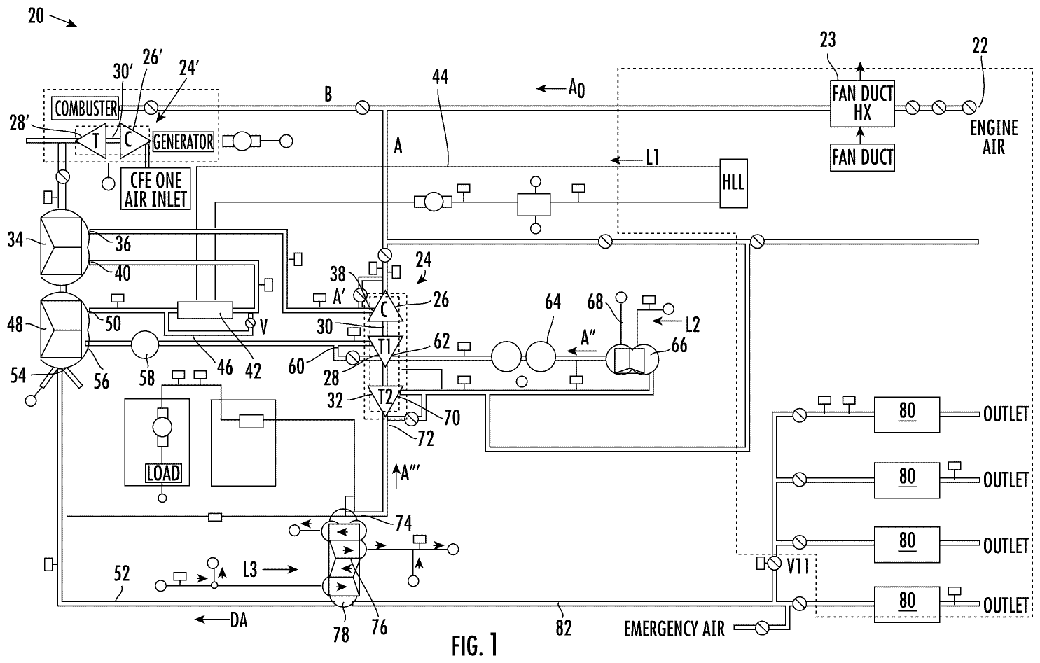

With reference now to FIG. 1, a schematic diagram of a portion of an existing environmental control system (ECS), such as an air conditioning unit or pack for example, is depicted according to non-limiting embodiments as illustrated. Although the environmental control system 20 is described with reference to an aircraft, alternative applications, such as another vehicle for example, are also within the scope of the disclosure. As shown in the figure, the ECS 20 can receive a medium Ao at an inlet 22. In an embodiment where the environmental control system 20 is used in an aircraft application, the medium Ao may be bleed air, which is pressurized air originating from, i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

In another embodiment, the medium Ao provided to the inlet 22 is fresh air, such as outside air for example. The outside air can be procured via one or more scooping mechanisms, such as an impact scoop or a flush scoop for example. In an embodiment, the medium Ao is ram air drawn from a portion of a ram air circuit. Generally, the fresh or outside air as described herein is at an ambient pressure equal to an air pressure outside of the aircraft when the aircraft is on the ground and is between an ambient pressure and a cabin pressure when the aircraft is in flight.

The ECS 20 additionally includes at least one thermodynamic device 24. The thermodynamic device 24 is a mechanical device that includes components for performing thermodynamic work on a medium (e.g., extracts work from or applies work to the medium A, which could be a portion of medium Ao, by raising and/or lowering pressure and by raising and/or lowering temperature). Examples of a thermodynamic device 24 include an air cycle machine, a two-wheel air cycle machine, a three-wheel air cycle machine, a four-wheel air cycle machine, etc. As shown, the thermodynamic device 24, also referred to herein as an air cycle machine, may include a compressor 26 and at least one turbine 28 operably coupled by a shaft 30. In an embodiment, the thermodynamic device 24 includes two turbines 28, 32. In such embodiments, the medium A may be configured to flow through the turbines 28, 32 in series, or alternatively, in parallel.

A compressor 26 is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc. A turbine, such as any of turbines 28 and 32 for example, is a mechanical device that expands a medium and extracts work therefrom (also referred to as extracting energy) to drive the compressor 26 via the shaft 30.

As shown, the medium Ao provided at the inlet 22 may be cooled within a heat exchanger 23 before being delivered to the thermodynamic device 24. The heat sink for the heat exchanger 23 used to cool the medium Ao may be ram air, engine fan air, or fuel. In the illustrated, non-limiting embodiment, the cooled medium A, a portion of the cooled medium Ao, is provided to an inlet of the compressor 26. The act of compressing the medium A heats up and increases the pressure of the medium A.

An inlet 36 of a first regeneration heat exchanger 34 is fluidly connected to the outlet 38 of the compressor 26. The compressed medium A′ output from the compressor outlet 38 may be cooled within the first heat exchanger 34. In the illustrated, non-limiting embodiment, the fluid used to cool the compressed medium A′ within the first regeneration heat exchanger 34 is a flow provided from an outlet of a second thermodynamic device 24′. As shown, the flow of medium A at a location downstream from the heat exchanger 23 may be split into a first portion A provided to the compressor 26 of the thermodynamic device 24 and a second portion B provided to a second thermodynamic device 24′. Some of the second portion B may be provided to a turbine 28′ of the second thermodynamic device 24′. Within the turbine 28′, energy is extracted from the second portion B of the medium and used to drive the compressor 26′ via a shaft 30′, thereby reducing both the pressure and the temperature of the second portion B of the medium. However, embodiments where another fluid is used to cool the compressed medium A′ within the first regeneration heat exchanger 34 are also within the scope of the disclosure.

In some embodiments, a first air-liquid heat exchanger 42 is located downstream from the outlet 40 of the first regeneration heat exchanger 34. Within the first air-liquid heat exchanger 42, thermal energy is transferred between the compressed medium A′ and a liquid L1 provided from a liquid loop 44 used to condition, for example cool, one or more loads of the vehicle. In an embodiment, heat is transferred from the compressed medium A′ to the liquid L of the first liquid loop 44 at the first air-liquid heat exchanger 42. However, a bypass conduit 46 having a valve V may be arranged in parallel with the first air-liquid heat exchanger 42 such that the compressed medium A′ output from the outlet 40 of the first regeneration heat exchanger 42 may bypass the first air-liquid heat exchanger 42.

Located downstream from the first air-liquid heat exchanger 42 and from the bypass conduit 46 is a second regeneration heat exchanger 48. Accordingly, a flow of compressed medium A′ output from at least one of the first air-liquid heat exchanger 42 and the bypass conduit 46 is provided to an inlet 50 of the second regeneration heat exchanger 48. In an embodiment, the second regeneration heat exchanger 48 may be an air-air heat exchanger configured to utilize excess cooling capacity of the ECS 20 to further cool the compressed medium A′. For example, as will be described in more detail below, part of a conditioned form of the medium ready to be delivered to one or more loads of the vehicle, such as the cockpit for example, may be diverted along a regeneration pathway 52 to a second inlet 54 of the second regeneration heat exchanger 50. At the second regeneration heat exchanger 50, the compressed medium A′ is cooled via thermal exchange with this diverted medium DA. The heated diverted medium DA may then be exhausted overboard or provided to another component of subsystem of the aircraft.

The further cooled compressed medium A′ output from the outlet 56 of the second regeneration heat exchanger 50 may have water removed therefrom, such as via a water collector or scupper 58 for example, before being provided to an inlet 60 of the turbine 28. It should be appreciated that at the water collector 58, the compressed medium A′ is at its highest pressure within the ECS 20, and therefore, the water collector 58 may be considered as a high-pressure water collector.

Within the turbine 28, energy is extracted from the compressed medium A′ to form an expanded medium A″. The work extracted from the compressed medium A′ in the turbine 28 drives the compressor 26. The pressure downstream of the first turbine 28 is at a middle pressure, a pressure lower than upstream from the first turbine 28 but higher than the pressure of the medium A′″ at the air cycle machine outlet (outlet of turbine 32). In an embodiment, the expanded medium A″ is provided to a middle-pressure water collector 64 configured to remove moisture therefrom. The middle-pressure water collector 64 is configured to coalesce the fog within the expanded medium A″ and remove free moisture from the flow of the expanded medium A″. The temperature of the expanded medium A″ output from an outlet 62 the turbine 28 may be above freezing to facilitate the water removal. In an embodiment, the temperature of the expanded medium A″ at and downstream from the outlet 62 of the turbine 28 is maintained above freezing when the aircraft is at lower altitudes where water may be present.

In the illustrated, non-limiting embodiment, the expanded medium A″ output from the turbine 28 is provided to another heat exchanger, such as a second air-liquid heat exchanger 66. At the second air-liquid heat exchanger 66, the expanded medium A″ is arranged in a heat transfer relationship with another liquid L2 provided from another liquid loop 68, such as used to cool one or more loads of the vehicle. Although the liquid loop 68 is illustrated and described herein as being distinct from the liquid loop 44 associated with the first air-liquid heat exchanger 42, it should be understood that the same liquid from the same liquid loop may be used to heat the medium A at both heat exchangers 42, 66. In such embodiments, the second air-liquid heat exchanger 66 is arranged downstream from the first air-liquid heat exchanger 42 relative to both the flow of the medium A and the flow of the liquid.

Regardless of the source of the liquid, within the second air-liquid heat exchanger 66, thermal energy is transferred between the expanded medium A″ and the liquid L2. In an embodiment, the expanded medium A″ is heated by the liquid L2 and the resulting cooler liquid L2 may then directed to one or more heat loads of the liquid loop 68. Because heat is transferred from the compressed medium A′ to the liquid L of the first liquid loop 44 at the first air-liquid heat exchanger 42, and heat is transferred from the liquid L2 of the second liquid loop 68 to the expanded medium A″ at the second air-liquid heat exchanger 42, the first liquid loop 44 may be considered a cooling loop and the second liquid loop 68 may be considered a heating liquid loop.

From the second air-liquid heat exchanger 66, the medium A″ may be provided to an inlet 70 of the second turbine 32. The energy extracted from the medium A″ within the second turbine 32 is also used to drive the compressor 26. The resulting expanded medium A′″ from an outlet 72 of the second turbine 32 is cooler and has a lower pressure than the medium A″ provided at the inlet thereof.

From the second turbine 32, the expanded medium A′″ is provided to an inlet 74 of a third heat exchanger. In an embodiment, the third heat exchanger is a third air-liquid heat exchanger 76 where the expanded medium A′″ is thermally coupled to a liquid L3. However, embodiments where the third heat exchanger is an air-air heat exchanger are also within the scope of the disclosure. The liquid L3 provided as the secondary fluid at the third air-liquid heat exchanger 76 may be the same liquid used in at least one of the first and second air-liquid heat exchangers 42, 66. In an embodiment, the third air-liquid heat exchanger 76 is arranged downstream from the second air-liquid heat exchanger relative to the flow of both the medium A and the liquid L2 of liquid loop 68. However, embodiments where the liquid L3 provided to the third air-liquid heat exchanger 76 is different than that provided to both the first air-liquid heat exchanger 42 and the second air-liquid heat exchanger 66 are also contemplated herein.

Within the third air-liquid heat exchanger 76, thermal energy is transferred between the expanded medium A′″ and the liquid L3. In an embodiment, the expanded medium A′″ is heated by the liquid L3, and the resulting cooler liquid L3 is then directed to one or more liquid cooled heat loads. The expanded medium A′″ at the outlet 78 of the third air-liquid heat exchanger 76 may be controlled between 0° F. and 35° F. depending on the altitude of the aircraft. The conditioned, expanded medium A′″ leaving the third air-liquid heat exchanger 76 may be provided to one or more loads, illustrated schematically at 80 via a conduit 82. These loads include but are not limited to three potential destinations: the cockpit, the forced air-cooled equipment, or a bay vent. In some embodiments, at least a portion of the conditioned, expanded medium A′″ at the outlet 78 of the third air-liquid heat exchanger 76 is provided to the second regeneration heat exchanger 48 via a regeneration pathway 52 (as the diverted air DA) previously described herein. It should be understood that the environmental control system 20 illustrated and described herein is intended as an example only, and that an ECS having another suitable flow configuration for conditioning one or more mediums is within the scope of the disclosure.

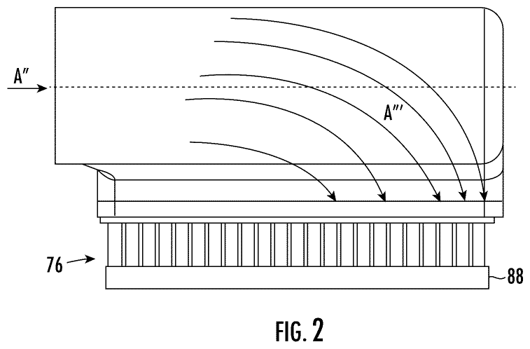

Due to the limited sizing envelope of an ECS 20, the flow path of the medium being conditioned therein typically includes several bends or turns. In some applications, an inlet of a component of an ECS 20 may be arranged at a non-zero angle relative to the flow path of medium A provided thereto. For example, in the non-limiting embodiment of FIG. 1, the inlet 74 of the third air-liquid heat exchanger 76 is oriented generally perpendicularly to the direction of flow of the medium A′″ from the outlet 72 of the second turbine 32. Accordingly, the medium A′″ output from the second turbine 32 must make a 90 degree turn to reach the inlet 74 of the third air-liquid heat exchanger 76. Such a turn in the flow path causes the flow of the medium, such as the medium A′″ for example, to be non-uniformly distributed across the inlet 74 of the heat exchanger 76 resulting in a reduced efficiency thereof. As shown in FIG. 2, it is difficult for the flow of the medium A′″ to make a sharp turn and as a result, the flow of the medium A′″ is typically concentrated towards a back or far side, identified at 88, of the heat exchanger 76. It should be appreciated that although a turn is illustrated and described herein with respect to the flow between the second turbine 32 and the third air-liquid heat exchanger 76, a flow between any two components of an ECS 20 arranged directly in series relative to a flow of a medium is within the scope of the disclosure.

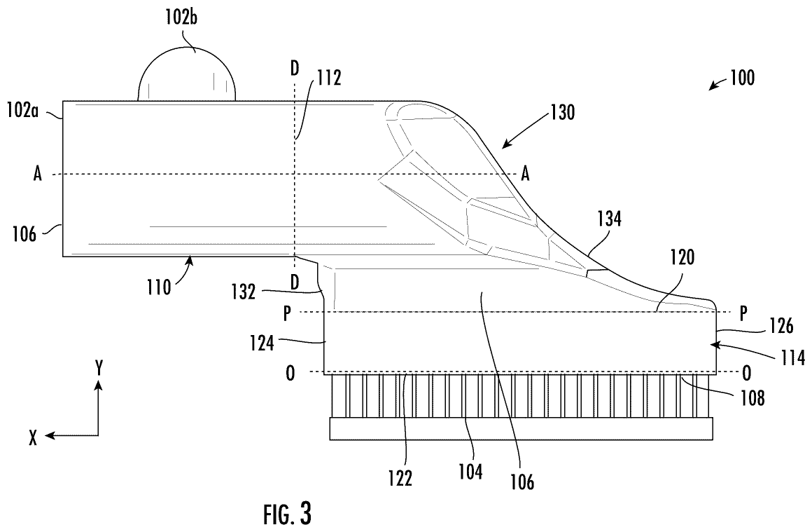

With reference now to FIGS. 3-8, an example of a header 100 associated with a turn in the flow path of an ECS 20 is illustrated. The header 100 includes a body having an inlet 102 formed therein and an outlet 104 formed therein, the inlet 102 and the outlet 104 being connected by a fluid flow path. In the illustrated, non-limiting embodiment, the header 100 has a plurality of inlets including a first or primary inlet 102a and a secondary inlet 102b. As shown, the primary inlet 102a may be arranged at a first or upstream end 106 of the header 100 and the secondary inlet 102b may be arranged downstream from the first end 106 of the header 100 relative to the flow path. However, embodiments including only a single inlet, such as the primary inlet for example, and embodiments including more than two inlets are also within the scope of the disclosure.

The outlet 104 of the header 100 may be arranged at a second or downstream end 108 of the header 100. In an embodiment, the outlet 104 is arranged within the plane O oriented parallel to the inlet of a downstream component, such as the heat exchanger 76 for example. In some embodiments, the size and/or shape of the outlet 104 may be substantially identical to that of the inlet of the downstream component fluidly connected directly or indirectly to the outlet 104.

The second end 108 is oriented at a non-parallel angle relative to the first end 106 of the header 100. Although the first end 106 and the primary inlet 102a is illustrated as being generally perpendicular to the second end 108 and outlet 104, embodiments where the second end 108 of the header 100 is oriented at another non-parallel angle relative to the first end 106 of the header 100, such as 45 degrees and 134 degrees for example, are also within the scope of the disclosure.

The body of the header 100 located directly adjacent to the at least one inlet 102 may have a generally constant interior cross-sectional shape extending between a first end thereof, such as the first end 106 and a second downstream location 112. In an embodiment, this portion 110 of the header 100 extending from the at least one inlet 102, also referred to herein as the inlet portion of the body, is generally cylindrical. The inner and/or outer diameter of this inlet portion 110 may be substantially identical to the diameter of a conduit or the outlet of a component located directly upstream from and fluidly connected to the primary inlet 102a of the header 100.

The body of the header 100 located adjacent to the outlet 104, such as at or directly upstream from outlet 104 for example, may have a generally constant interior cross-sectional shape. As previously noted, this internal cross-sectional shape may be substantially identical to that of the inlet of the downstream component. In an embodiment, this portion 114 of the header 100 arranged at or directly upstream from the outlet 104, also referred to herein as the outlet portion of the body, is generally rectangular. In such embodiments, the outlet portion 114 may have an upstream end 120, a downstream end 122 (forming the second end 108 of the header), a front side 124, and back side 126. The front side 124 may be arranged closer to the downstream end 112 of the inlet portion 110 than the back side 126. Similarly, the upstream end 120 is positioned closer to the inlet portion 110 than the downstream end 122 relative to the flow path of the header 100. Although the outlet portion 114 is illustrated and described herein as having a constant cross-sectional area over a portion of the flow path, it should be understood that embodiments where the outlet portion 114 is defined only by the second end 108 of the header 100 is also contemplated herein. In such embodiments, the outlet portion 114 may have a front edge instead of a front side, a back edge instead of a back side, and two lateral edges (similar to the two lateral sides described below) connected to the front edge and back edge.

The inlet portion 110 of the header 100 is laterally spaced from the outlet portion 114. In an embodiment, the longitudinal axis A of the inlet portion 110 is separated or spaced from the plane P of the upstream end 120 of the outlet portion 114 and/or the plane O at the downstream end 122 or outlet 108 in a first direction extending along a first axis, indicated in FIG. 3 as the Y-axis. Further, the inlet portion 110 may be offset from the outlet portion 114 in a second direction aligned with a second axis, indicated as the X axis, oriented generally perpendicular to the first axis Y. For example, the front side 124 of the outlet portion 114 may be generally aligned with the downstream end 112 of the inlet portion 110. However, in other embodiments, the front side 124 of the outlet portion 114 is spaced from the plane D of the downstream end 112 of the inlet portion 110 along the X-axis. The outlet portion 114 may partially overlap the inlet portion such that the front side 124 is located closer to the first end 106 of the inlet portion 110 than the plane P. Alternatively, a gap or clearance may be formed between the front side 124 of the outlet portion 114 and the plane P such that no part of the outlet portion 114 overlaps with the inlet portion 110 along the X axis.

An intermediate portion 130 of the header 100 extends between and fluidly couples the downstream end 112 of the inlet portion 110 to the upstream end 120 of the outlet portion 114. As shown, the intermediate portion 130 generally includes a plurality of sidewalls that extend between the inlet portion 110 and the outlet portion 114. In the previous header design, shown in FIG. 2, the intermediate portion extended along the longitudinal axis of the inlet portion a plane aligned with the back side or back edge of the outlet portion. However, in the header shown in FIGS. 3-7, the intermediate portion is contoured such that the intermediate portion is offset from the longitudinal axis X at the back side or back edge 126 of the outlet portion 114.

In embodiments where the outlet portion 114 is generally rectangular, the plurality of sidewalls generally include a front sidewall 132 connected to the front side 124 of the outlet portion 114, a back sidewall 134 connected to the back side 126 of the outlet portion 114, and a first and second lateral sidewall 136, 138 connected to respective first and second lateral sides 127, 128 of the outlet portion 114 extending between the front side 124 and the back side 126 thereof. The interface between adjacent sidewalls 132-138 may be curved to prevent the formation of any creases or pockets where the flow of medium is likely to become trapped.

Because the cross-sectional flow area at the downstream end 112 of inlet portion 110 is less than the cross-sectional area at the outlet portion 114, one or more of the plurality of walls 132-138 may be contoured to achieve a gradual increase in cross-sectional flow area over from the inlet portion 110 to the outlet portion 114. In an embodiment, at least one, and in some embodiments, each of the plurality of sidewalls 132-138 has a concave curvature extending towards an interior of the header 100 to achieve a gradual increase in cross-sectional area. This increase may help diffuse the flow of air provided from the inlet portion 110 across the entire flow path.

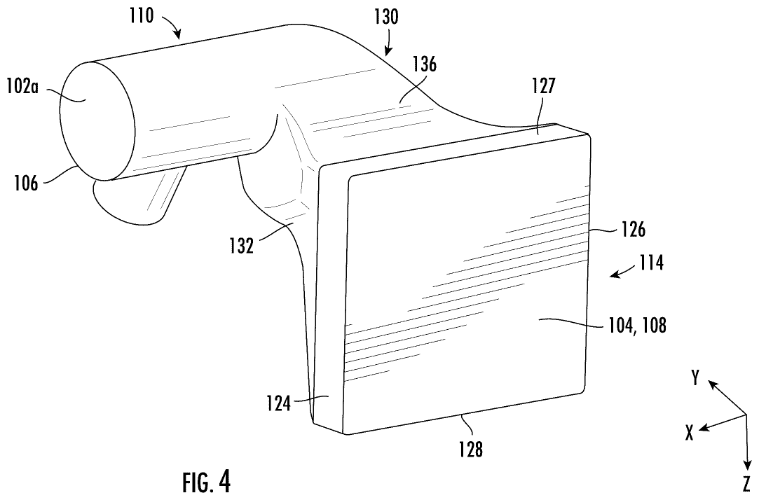

With reference to FIGS. 4-6, in the illustrated, non-limiting embodiment, the intermediate portion 130 of the header 100 additionally includes an internal cavity or reservoir 140. The plurality of sidewalls 132-138 of the intermediate portion, in combination, may define the reservoir 140. Such a reservoir 140 may be achieved by varying the contour of the respective sidewalls 132-138. For example, one or more of the sidewalls 132-138 may have an angle or bend formed therein to define at least a portion of the reservoir 140.

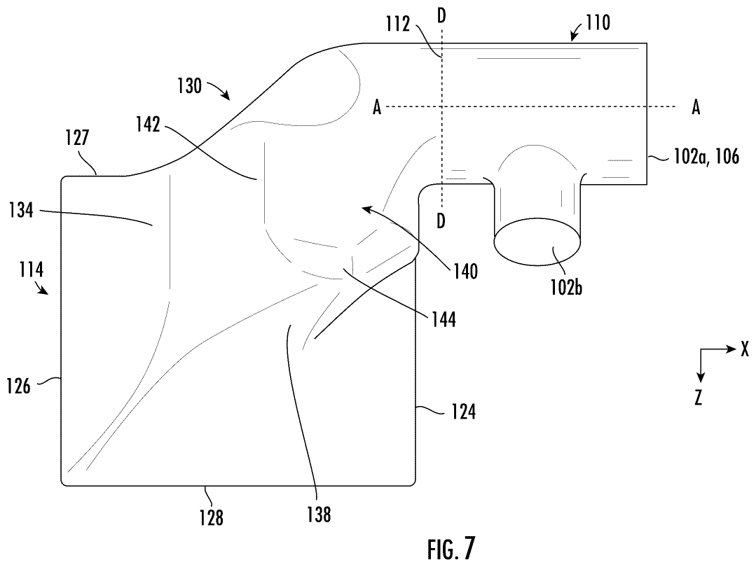

The reservoir 140 may be located downstream from and generally adjacent to the downstream end 112 of the inlet portion 110. In an embodiment, the reservoir 140 extends from the downstream end 112 of the inlet portion 110 along the axis X. As shown, the reservoir 140 extends along the longitudinal axis X over only a portion of an axial length of the outlet portion 114 defined between the front side 124 and the back side 126 thereof. For example, as best shown in FIG. 7, the reservoir 140 extends generally to a middle of the outlet portion 114 of the header 100 between the front side 124 and the back side 126. However, embodiments where the reservoir 140 extends to an axial location arranged closer to either the front side 124 or the back side 126 of the outlet portion 114 are also contemplated herein. In the illustrated, non-limiting embodiment, the respective side of the reservoir 140, illustrated generally at 142, used to determine the extension of the reservoir 140 along the X-axis is formed by the back sidewall 134 and the curvature of the back sidewall 134 is controlled accordingly.

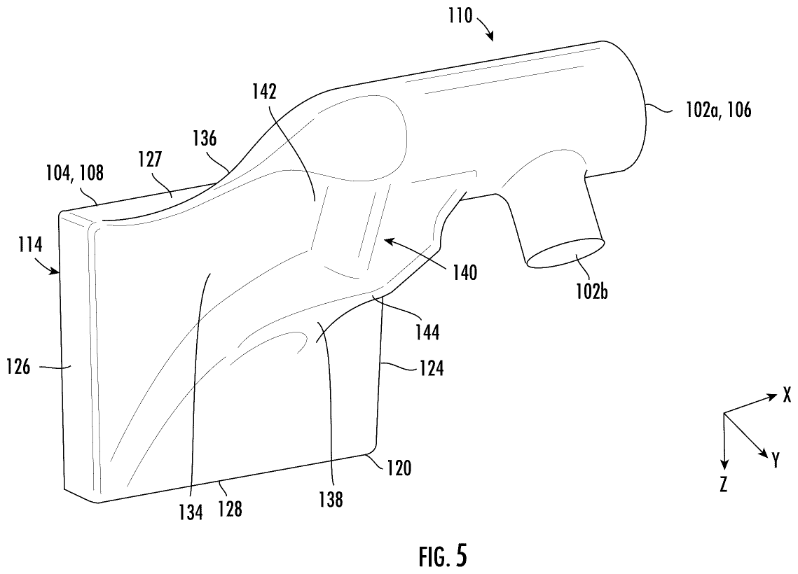

Alternatively, or in addition, the reservoir 140 may extend from the downstream end 112 of the inlet portion 110 along a third axis, illustrated as the Z-axis in FIGS. 5 and 7. In the illustrated, non-limiting embodiment, the reservoir 140 extends along the Z-axis toward the lateral side 128 of the outlet portion 114 such that an end or bottom of the reservoir 140, generally represented by 144, is offset from the inlet portion 110 by a distance. Accordingly, as a flow passes from the inlet portion 110 into the intermediate portion 130, at least a portion of the flow may turn such that the flow moves along the third axis Z as it enters the reservoir 140.

Further, only a portion of the reservoir 140 may overlap with only the outlet portion 114 relative to the Z-axis. For example, the reservoir 140 may be generally aligned with or overlap the outlet portion 114 near the interface between the lateral side or edge 127 and the front side or edge 124 thereof. In such embodiments, a length of the lateral sidewall 136 measured along the Z-axis may be significantly shorter than a length of the lateral sidewall 138 measured along the Z-axis.

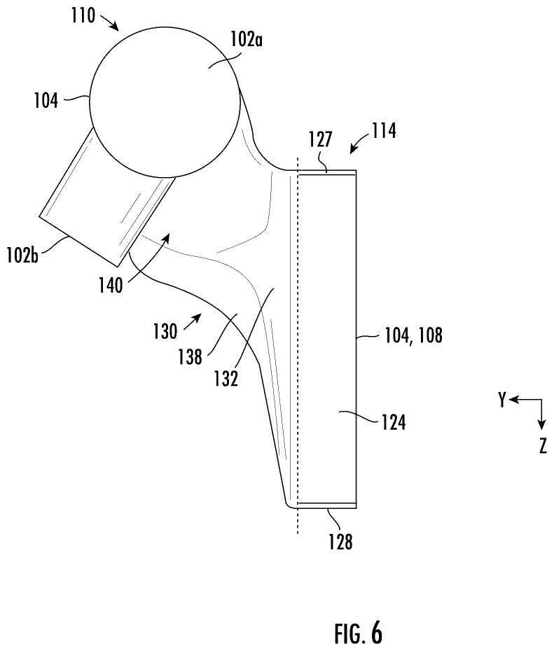

With reference to FIG. 6, in an embodiment, the reservoir 140 is positioned between the inlet portion 110 and the upstream end 120 of the outlet portion 114 relative to the Y-axis. As shown, at least a portion of the reservoir 140, and in some embodiments a majority of the reservoir 140 is in overlapping arrangement with the inlet portion 110 along the Y axis. However, the reservoir 140 may not overlap with the outlet portion 114 along the Y-axis. Accordingly, as the flow passes from the inlet portion 110 into the intermediate portion 130, at least a portion of the flow provided to the reservoir 140 may turn such that the flow moves along the Y-axis as it enters or exits the reservoir 140.

The turn resulting in movement along the Y-axis may occur simultaneously with or sequentially with the turn resulting in movement of the flow along the Z-axis. In an embodiment, the flow provided to the header 100 is configured to turn first along the Z-axis and turn second along the Y-axis as it passes through the header 100. One or both of these turns may slow the momentum of the flow within the header 100, thereby preventing the formation of large vortices within the flow.

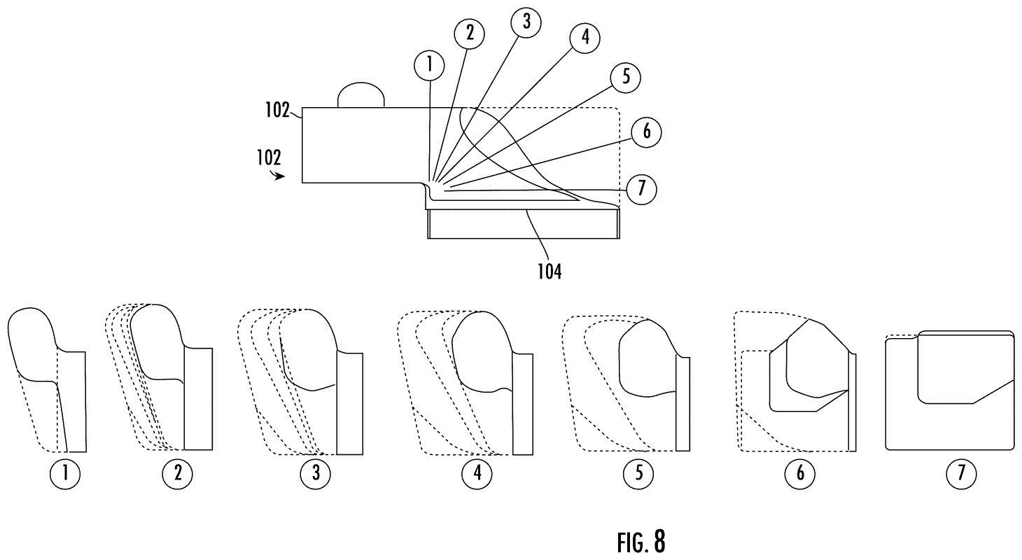

With reference to FIG. 8, a header 100 according to the embodiments described herein is overlaid over a previously used header. Further, various cross-sections of the header 100 and the previous header are taken at different planes between the inlet 102 and the outlet 104. These cross-sections illustrate the gradual increase in the area of the flow path between the downstream end 112 of the inlet portion 110 and the outlet portion 114.

By positioning the reservoir 140 adjacent to the corner of the outlet portion 114 located closest to the inlet portion 110, the sidewalls 132-138 extending from the reservoir to the upstream end 120 of the outlet portion 114 facilitate diffusion of the flow over the entire cross-sectional area of the flow path. This diffusion that occurs downstream of the reservoir 140 results in a more uniform and evenly distributed flow at the outlet 104.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A component for use in an environmental control system comprising:
an inlet portion having a longitudinal axis;
an inlet formed at the inlet portion;
an outlet portion including a front side and a back side, the front side being arranged closer to the inlet portion than the back side;
an outlet formed at the outlet portion, the outlet being arranged at a non-parallel angle relative to the inlet; and
an intermediate portion extending between and fluidly coupling the inlet portion and the outlet portion, wherein the intermediate portion includes a reservoir, the reservoir being spaced laterally from the back side of the outlet portion and offset from the longitudinal axis of the inlet portion.

2. The component of claim 1, wherein the intermediate portion at the back side is spaced from the longitudinal axis.

3. The component of claim 1, wherein the inlet portion is offset from the outlet portion in a plurality of axes.

4. The component of claim 1, wherein a flow path extends between the inlet and the outlet and the reservoir is offset from the inlet portion such that the flow path includes a turn from a downstream end of the inlet portion toward the reservoir.

5. The component of claim 1, wherein a flow path extends between the inlet and the outlet and the reservoir is offset from the outlet portion such that the flow path includes a turn from the reservoir toward the outlet portion.

6. The component of claim 1, wherein the reservoir extends over only a portion of an axial length of the outlet portion between the front side and the back side.

7. The component of claim 1, wherein the intermediate portion further comprises a plurality of sidewalls and the plurality of sidewalls define the reservoir.

8. The component of claim 7, wherein an interface between adjacent sidewalls of the plurality of sidewalls are curved.

9. The component of claim 7, wherein at least one of the plurality of sidewalls is contoured such that a cross-sectional area of the component gradually increases between the reservoir and the outlet portion.

10. The component of claim 7, wherein the plurality of sidewalls includes a back sidewall extending between the reservoir and the back side of the outlet portion, the back sidewall having a concave curvature.

11. The component of claim 1, wherein the outlet is perpendicular to the inlet.

12. A component for use in an environmental control system comprising:
an inlet portion having a longitudinal axis;
an inlet formed at the inlet portion;
an outlet portion including a front side and a back side, the front side being arranged closer to the inlet portion than the back side;
an outlet formed at the outlet portion, the outlet being arranged at a non-parallel angle relative to the inlet; and
an intermediate portion extending between and fluidly coupling the inlet portion and the outlet portion, wherein the intermediate portion is contoured such that the intermediate portion is offset from the longitudinal axis at the back side of the outlet portion.

13. The component of claim 12, wherein the inlet portion is offset from the outlet portion in a plurality of axes.

14. The component of claim 12, wherein the intermediate portion further comprises a plurality of sidewalls and an interface between adjacent sidewalls of the plurality of sidewalls are curved.

15. The component of claim 14, wherein at least one of the plurality of sidewalls is contoured such that a cross-sectional area of the component gradually increases upstream from the outlet portion.

16. The component of claim 15, wherein at least one of the plurality of sidewalls has a concave curvature.

17. The component of claim 12, wherein the intermediate portion further comprises a reservoir, the reservoir being offset from the longitudinal axis of the inlet portion.

18. The component of claim 17, wherein the reservoir is spaced laterally from the back side of the outlet portion.

19. The component of claim 17, wherein the intermediate portion further comprises a plurality of sidewalls and the plurality of sidewalls define the reservoir.
